(19) United States
(12) Patent Application Publication
(10) Pub. No.: US 2025/0109341 A1
(43) Pub. Date: Apr. 3, 2025

(54) A METHOD FOR PRODUCING RENEWABLE C3-C8 HYDROCARBONS

(71) Applicant: NESTE OYJ, Espoo (FI)

(72) Inventors: John JAMIESON, Porvoo (FI); Marja TIITTA, Porvoo (FI); Eveliina MÄKELÄ, Porvoo (FI); Sylvia ALBERSBERGER, Porvoo (FI)

(21) Appl. No.: 18/724,088

(22) PCT Filed: Nov. 21, 2022
(86) PCT No.: PCT/FI2022/050767

§ 371 Date: Jun. 25, 2024

(30) Foreign Application Priority Data
Dec. 27, 2021 (FI) 20216357

(51) Int. Cl. C10G 65/12; B01J 29/04; B01J 29/06; B01J 29/70; C10G 47/16

(52) U.S. Cl. CPC C10G 65/12; B01J 29/043; B01J 29/7007; B01J 29/7046; C10G 47/16; B01J 2029/062; B01J 2523/68; B01J 2523/845; B01J 2523/847; C10G 2300/201

(57) ABSTRACT

The present invention relates to a method for producing renewable C3-C8 hydrocarbons D from renewable feedstock A, in particular to methods comprising separate hydrodeoxygenation (20) hydrocracking (40) steps, wherein the hydrocracking is performed using metal impregnated mesoporous molecular sieves embedded with ZSM-23 zeolite or Beta zeolite as catalyst.

### CROSS-REFERENCE TO RELATED APPLICATIONS

This application is the U.S. national phase of International Application No. PCT/FI2022/050767 filed Nov. 21, 2022 which designated the U.S. and claims priority to FI 20216357 filed Dec. 27, 2021, the entire contents of each of which are hereby incorporated by reference.

### FIELD

The present invention relates to a method for producing C3-C8 hydrocarbons from renewable feedstock, in particular to methods comprising hydrodeoxygenation of the feedstock followed by hydrocracking using embedded zeolite catalysts.

### BACKGROUND

Petrochemicals are a growing business area and propylene is the second most important starting material in the petrochemical industry after ethylene. Nearly two thirds of all demand of propylene is used for manufacturing of polypropylene. There is an increasing demand to use renewable polyethene and polypropylene. However, there is very limited production capacity available for producing renewable chemicals that may be used in polymerization processes, and steam cracking of naphtha cannot meet the demand alone. Fluid catalytic cracking (FCC) is expected to be one of the main sources of propylene. Propylene is also manufactured from propane via dehydrogenation.

WO2006/070073 discloses mesoporous molecular sieves embedded with a zeolite which are suitable for hydrocarbon conversion reactions and particularly for processing of high molecular weight hydrocarbons. When metal-modified, these mesoporous materials were shown to be active in isomerization of long chain paraffins, hydrogenation, hydrocracking, hydrodesulfurization, hydrodeoxygenation, hydrodenitrogenation, dehydrogenation, reforming, Fischer-Tropsch, and oxidation reactions.

EP2253608 discloses a method for simultaneous hydrogenation and isomerization of olefins having at least 10 carbon atoms using mesoporous molecular sieves embedded with zeolite, such as platinum impregnated MCM-41 embedded with ZSM-23 on an alumina support yielding isoparaffins having substantially same carbon number as the feedstock. The method disclosed therein is optimized for the production of diesel fuel, whereas hydrocracked products, such as naphtha and propane, were only minor components.

US2021087480A1 discloses a method for producing renewable hydrocarbon lighter fluid including hydrotreating renewable feedstock followed by hydrocracking the heavy fraction formed to produce hydrocarbon components, typically C3-C18 hydrocarbons, which are fractionated to recover the lighter fluid product. The hydrocracking catalyst used was a bi-functional catalyst including platinum over an acidic crystalline support comprising silica and alumina.

US20090270245A1 discloses method for manufacture of mesoporous molecular sieves embedded with zeolite.

Accordingly, there is still a need for further methods for producing renewable hydrocarbons.

### SUMMARY

The present invention is based on the observation that when a renewable feedstock is hydrodeoxygenated followed by hydrocracking in the presence of certain catalyst based on molecular sieves embedded with zeolite, renewable C3-C8 hydrocarbons may be manufactured.

Accordingly, it is an object of the present invention to provide a method for producing renewable C3-C8 hydrocarbons from a renewable feedstock, the method comprising the following steps
a) providing the renewable feedstock,
b) pre-treating the renewable feedstock by reducing the amount of impurities therein not to include: more than 10 w-ppm alkali metal and alkaline earth metal impurities, calculated as elemental alkali metals and alkaline earth metals; more than 10 w-ppm other metals, calculated as elemental metals; more than 1000 w-ppm nitrogen containing impurities, calculated as elemental nitrogen; more than 30 w-ppm phosphorus containing impurities, calculated as elemental phosphorus; to produce a pre-treated feedstock,
c) subjecting the pre-treated feedstock to hydrodeoxygenation reaction to produce a hydrodeoxygenated stream, wherein the hydrodeoxygenation reaction comprises one or more of:
   a. a temperature in the range from 250° C. to 400° C.,
   b. a pressure in the range from 10 bar to 200 bar,
   c. a WHSV in the range from 0.25 h⁻¹ to 3 h⁻¹,
   d. a H₂ flow from 350 to 1500 N-L H₂/L feed, and
   e. a hydrodeoxygenation catalyst selected from Pd, Pt, Ni, Co, Mo, Ru, Rh, and W or any combination thereof, on a support,
to produce a hydrodeoxygenated stream,
d) subjecting the hydrodeoxygenated stream to a gas-liquid separation thereby producing a gaseous stream and a hydrodeoxygenated liquid stream,
e) subjecting the hydrodeoxygenated liquid stream to hydrocracking reaction comprising a temperature in the range from 250° C. to 420° C., hydrogen, and a catalyst comprising
   i. a hydrogenation metal,
   ii. a mesoporous molecular sieve embedded with ZSM-23 or Beta zeolite obtainable by a method comprising the following steps
      A. preparing a zeolite nuclei from a silicon source, an aluminum source and a structure directing agent and optionally removing the structure directing agent with a step calcination procedure,
      B. preparing a mesoporous molecular sieve gel mixture from a silicon source, an optional aluminum source, and surfactant,
      C. introducing the zeolite nuclei prepared in the step A to the mesoporous molecular sieve gel mixture obtained in the step B and homogenizing and dispersing in the molecular sieve gel zeolite nuclei and introducing an additional aluminum source to the obtained mixture,
      D. performing gel ripening of the mixture of step C under stirring,
      E. carrying out hydrothermal synthesis of the mixture of the step D by maintaining the mixture under sufficient conditions including a temperature of from about 100° C. to about 200° C. under static or dynamic mode of stirring until crystals are formed,
      F. recovering the crystals,
      G. washing off the solid products,
      H. drying the solid products, and
      I. removing the surfactant partly or totally with a step calcination procedure and optionally the structure directing agent if it was not removed in step A, whereby said mesoporous molecular sieve embedded with said zeolite is obtained, and
   iii. a carrier
to yield a hydrocracked stream, and
f) separating the renewable C3-C8 hydrocarbons from the hydrocracked stream.

It is also an object of the present invention to provide use of a catalyst comprising a hydrogenation metal, mesoporous molecular sieve embedded with ZSM-23 zeolite or with Beta zeolite obtainable by a method comprising
A. preparing a zeolite nuclei from a silicon source, an aluminum source and a structure directing agent and optionally removing the structure directing agent with a step calcination procedure,
B. preparing a mesoporous molecular sieve gel mixture from a silicon source, an optional aluminum source, and surfactant,
C. introducing the zeolite nuclei prepared in the step A to the mesoporous molecular sieve gel mixture obtained in the step B and homogenizing and dispersing in the molecular sieve gel zeolite nuclei and introducing an additional aluminum source to the obtained mixture,
D. performing gel ripening of the mixture of step C under stirring,
E. carrying out hydrothermal synthesis of the mixture of the step D by maintaining the mixture under sufficient conditions including a temperature of from about 100° C. to about 200° C. under static or dynamic mode of stirring until crystals are formed,
F. recovering the crystals,
G. washing off the solid products,
H. drying the solid products, and
I. removing the surfactant partly or totally with a step calcination procedure and optionally the structure directing agent if it was not removed in step A, whereby a mesoporous molecular sieve embedded with said zeolite is obtained, and a carrier for producing renewable C3-C8 hydrocarbons from a renewable paraffinic feed by hydrocracking at a temperature from 250° C. to 420° C. in the presence of a hydrogen flow.

A number of exemplifying and non-limiting embodiments of the invention are described in accompanied dependent claims.

Various exemplifying and non-limiting embodiments of the invention together with additional objects and advantages thereof, will be best understood from the following description of specific exemplifying and non-limiting embodiments when read in connection with the accompanying figures.

The verbs “to comprise” and “to include” are used in this document as open limitations that neither exclude nor require the existence of also un-recited features. The features recited in dependent claims are mutually freely combinable unless otherwise explicitly stated. Furthermore, it is to be understood that the use of “a” or “an”, i.e., a singular form, throughout this document does not exclude a plurality.

### BRIEF DESCRIPTION OF DRAWINGS

FIG. 1 shows an exemplary schematic presentation of catalytic material comprising mesoporous molecular sieve embedded with zeolite.

FIG. 2 shows an exemplary non-limiting schematic overview of producing renewable C3-C8 hydrocarbons from a renewable feedstock.

### DESCRIPTION

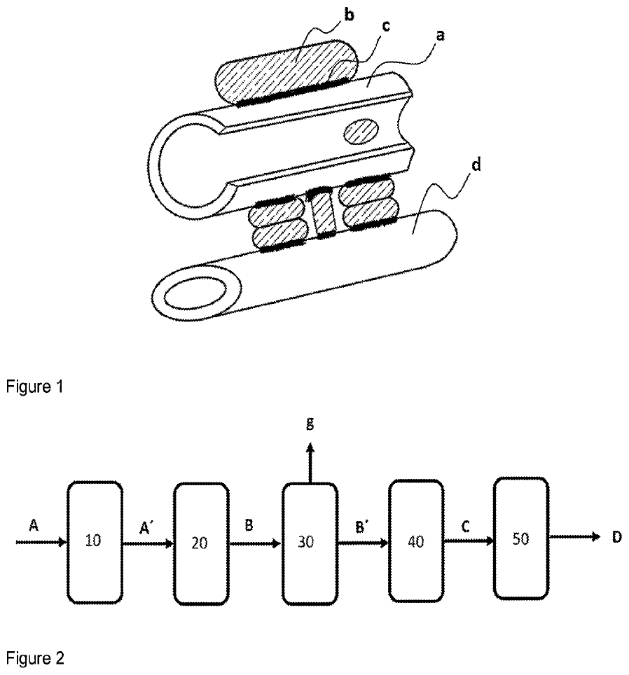

The expression mesoporous molecular sieve embedded with zeolite refers to a catalyst having mesoporous molecular sieve structure and zeolite structure in the same material. The catalyst includes ordered arrangement of cylindrical (tube-like) mesopore structures of the molecular sieve, and the zeolitic particles are bonded together through a covalent bond evidenced by good thermal stability. The mesoporous molecular sieve with embedded zeolite, and production thereof is disclosed and discussed further in the patent FI119801 An exemplary non-limiting schematic presentation of mesoporous molecular sieve embedded with zeolite is shown in a schematic FIG. 1. Accordingly, mesoporous molecular sieve embedded with zeolite comprises molecular sieve tubes a (intact) and d (flattened) and zeolite particles b which are attached to the molecular sieve structure via covalent bonding c (black). The zeolite particles shown in the figure are chemically bonded not only on the surface of the molecular sieve, but they may reside also inside the cylindrical mesoporous molecular sieve tubes. This, in turn, distorts the mesoporous molecular sieve tubes towards an elliptical form. This diverts the structure from composite or layered structures such as the ones disclosed e.g., in Kloetstra K. R. et al., Overgrowth of Mesoporous MCM-41 on Faujasite, Microporous Materials, Elsevier Science BV, Amsterdam, NL, vol 6, no 5/06, 1996, pp 287-293.

FIG. 2 shows an exemplary process of the present invention for producing renewable C3-C8 hydrocarbons from a feedstock of biological origin. In the figure reference numbers and arrows illustrate reactions and streams, respectively.

According to one embodiment method comprises the following steps:
a) providing a renewable feedstock of biological origin, A,
b) subjecting the feedstock to a pre-treatment step 10 to produce a pre-treated feedstock A′,
c) subjecting the pre-treated feedstock to hydrodeoxygenation 20 reaction to produce hydrodeoxygenated stream B,
d) subjecting the hydrodeoxygenated stream to a gas-liquid separation 30 thereby producing a gaseous stream g and a hydrodeoxygenated liquid stream B′,
e) subjecting the hydrodeoxygenated liquid stream to hydrocracking 40 reaction to produce a hydrocracked stream C, and
f) separating 50 the renewable C3-C8 hydrocarbons D from the hydrocracked stream.

### The Feedstock

A process for preparing hydrocarbons from an oxygenated renewable hydrocarbon feedstock is disclosed. Examples of oxygenated hydrocarbon feedstocks are fatty acids and triglycerides, which are present in large amounts in e.g., plant oils and animal fats. An oxygenated hydrocarbon feedstock of renewable origin, such as plant oils and animal fats, is well suited for the process. The majority of these plant oils and animal fats are typically composed of fatty acids, either as free fatty acids or as esters of free fatty acids, such as fatty acids of 25 wt-% (weight percent) or 40 wt-% or more. Examples of esters of free fatty acids are fatty acid glyceride esters (mono-, di- and/or tri-glyceridic) or for example the fatty acid methyl esters (FAME) or fatty acid ethyl esters (FAE). Accordingly, the oxygenated hydrocarbon feedstocks of renewable origin may contain 25 wt-% or more of fatty acids or fatty acid esters.

The renewable character of carbon-containing compositions, such as feedstocks and products of biological origin i.e., renewable feedstock and products, can be determined by comparing the ¹⁴C-isotope content of the feedstock to the ¹⁴C-isotope content in the air in 1950. The ¹⁴C-isotope content can be used as evidence of the renewable origin of the feedstock or product. Carbon atoms of renewable material comprise a higher number of unstable radiocarbon (¹⁴C) atoms compared to carbon atoms of fossil origin. Therefore, it is possible to distinguish between carbon compounds derived from biological sources, and carbon compounds derived from fossil sources by analyzing the ratio of ¹²C and ¹⁴C isotopes. Thus, a particular ratio of said isotopes can be used to identify and quantify renewable carbon compounds and differentiate those from non-renewable i.e., fossil carbon compounds. The isotope ratio does not change in the course of chemical reactions. Examples of a suitable method for analyzing the content of carbon from biological sources is ASTM D6866 (2020). An example of how to apply ASTM D6866 to determine the renewable content in fuels is provided in the article of Dijs et al., Radiocarbon, 48(3), 2006, pp 315-323. For the purpose of the present invention, a carbon-containing material, such as a feedstock or product is considered to be of renewable origin if it contains 90% or more modern carbon, such as 100% modern carbon, as measured using ASTM D6866.

The feedstock may include animal and fish oils/fats, plant oils and/or vegetable oils and/or microbial oils like babassu oil, palm seed oil, carinata oil, olive oil, coconut butter, soybean oil, canola oil, coconut oil, muscat butter oil, rapeseed oil, peanut oil, sesame oil, maize oil, sunflower oil, poppy seed oil, cottonseed oil, soy oil, laurel seed oil, crude tall oil, tall oil, tall oil fatty acid, tall oil pitch, crude palm oil, palm oil, palm oil fatty acid distillate, jatropha oil, palm kernel oil, camelina oil, archaeal oil, bacterial oil, fungal oil, protozoal oil, algal oil, seaweed oil, mustard seed oil, oils from halophiles, lauric-myristic acid group (C12-C14) including milk fats, palmitic acid group (C16) including earth animal fats, stearic acid group (C18) including earth animal fats, linoleic acid group (unsaturated C18) including whale and fish oils, erucic acid group (unsaturated C22) including whale and fish oils, oleo stearic acid group (conjugated unsaturated C18) including whale and fish oils, fats with substituted fatty acids (ricin oleic acid, C18) such as castor oil, and mixtures of any two or more thereof.

The oils of the feedstock may be classified as crude, degummed such as water and/or acid degummed, heat treated, and RBD (refined, bleached, and deodorized) grade, depending on the level of pre-treatment and residual phosphorus and metals content. Animal fats and/or oils may include inedible tallow, edible tallow, technical tallow, floatation tallow, lard, poultry fat, poultry oils, fish fat, fish oils, and mixtures of any two or more thereof. Greases may include yellow grease, brown grease, waste vegetable oils, restaurant greases, trap grease from municipalities such as water treatment facilities, and spent oils from industrial packaged food operations, and mixtures of any two or more thereof.

The feedstock may include derivatives of natural fats include mono- or diglycerides of C10-C28 fatty acids, C10-C28 fatty acids, C10-C28 fatty acid anhydrides, non-glyceride C10-C28 fatty acid esters, C10-C28 fatty alcohols, C10-C28 fatty aldehydes and C10-C28 fatty ketones. The C10-C28 fatty acids, their mono- and diglycerides, are typically prepared by hydrolysis of the corresponding triglyceride. The non-glyceride C10-C28 fatty acid esters are mainly prepared from the triglycerides by transesterification. The C10-C28 fatty alcohols, aldehydes and ketones are prepared by reduction, usually by hydrogenation, of the corresponding fatty acids. Advantageously, the feedstock hydrocarbons may be of C10-C24.

The derivatives of natural fats also include any of the aforementioned natural fats and derivatives, the hydrocarbon chain of which has been modified e.g., by substitution, branching or saturation.

An exemplary feedstock comprises at least triglycerides. Most typical exemplary feedstocks are animal fats and palm oil fatty acid, especially those originating from waste and residues.

A further exemplary feedstock comprises at least fatty acids. Most typical feedstock are various plant oils, and e.g., tall oil materials, such as crude tall oil.

The natural fats or derivatives thereof may be provided in pure form or as part of a feedstock containing other components. Preferably, the feedstock contains at least 20 wt-%, more preferably at least 30 wt-%, most preferably at least 40 wt-%, of pure natural fat or natural oil or their derivatives.

An exemplary renewable feedstock preferably includes waste and residue materials originating from animal fat/oil, plant fat/oil or fish fat/oil. These may comprise sludge palm oil, such as palm effluent sludge (PES) or palm oil mill effluent (POME), used cooking oil (UCO), acid oils (ASK), brown grease (BG), sludge palm oil, spent bleaching earth oil (SBEO), technical corn oil (TCO) or lignocellulosic based oils, municipal solid waste-based oils or algae-based oils. Most preferably, the feeds include UCO, sludge palm oil, TCO and algae-based oils.

### Pre-Treatment

Typically, the waste and residue materials contain a wide variety of heteroatomic compounds, which often are more difficult to remove by conventional feedstock pre-treatments typically used for pre-treatment of matrices comprising triacylglycerols. The waste and residue materials may comprise accumulated alkali metals and alkaline earth metals, such as sodium, potassium, calcium, magnesium; other metals such as iron or copper; nitrogen containing compounds, such as amines and amides; phosphorus containing compounds, such as phospholipids; silicon containing compounds, such as siloxanes and polydimethylsiloxanes (PDMS); halides, sulphur containing compounds, etc. depending on the type of residue/waste. These materials are typically harmful for the catalyst used in hydrotreatment and isomerization and need to be decreased or removed before entering the feedstock onto the catalysts.

Depending on the level of pre-treatment, fats, oils, and greases may contain high amounts of impurity materials e.g., about 1-1000 w-ppm (ppm by weight) phosphorus; and about 1-500 w-ppm total metals, mainly sodium, potassium, magnesium, calcium, iron, and copper. Nor is it uncommon that animal fat can contain e.g., 1000 w-ppm or even higher nitrogen measured as elemental nitrogen.

The feedstock of the present method needs to be suitable for hydrodeoxygenation. Typically, the feedstock entering into a hydrodeoxygenation reactor or a catalyst bed thereof should not include more than 10 w-ppm, preferably not more than 5 w-ppm, more preferably not more than 1 w-ppm alkali metal and alkaline earth metal impurities, calculated as elemental alkali metals and alkaline earth metals; not more than 10 w-ppm, preferably not more than 5 w-ppm, more preferably not more than 1 w-ppm other metals, calculated as elemental metals; not more than 1000 w-ppm, preferably not more than 500 w-ppm, more preferably not more than 150 w-ppm, most preferably not more than 50 w-ppm, such as not more than 5 w-ppm, such as not more than 1 w-ppm nitrogen containing impurities, calculated as elemental nitrogen; not more than 30 w-ppm, preferably not more than 15 w-ppm, more preferably not more than 5 w-ppm, such as not more than 1 w-ppm phosphorus containing impurities, calculated as elemental phosphorus; not more than 5 w-ppm, preferably not more than 1 w-ppm silicon containing impurities, calculated as elemental silicon; optionally not more than 100 w-ppm, preferably not more than 50 w-ppm, most preferably not more than 30 w-ppm, such as not more than 10 w-ppm, such as not more than 5 w-ppm sulphur containing impurities, calculated as elemental sulphur, and optionally not more than 20 w-ppm, preferably not more than 10 w-ppm, more preferably not more than 5 w-ppm chlorine containing impurities, calculated as elemental chlorine. Depending on the efficiency of the hydrotreating catalyst bed system and the hydrotreatment reactor unit configuration even a high amount of nitrogen impurities in the feed may be tolerated, and the effluent from the HDO may contain suitably low amount of nitrogen impurities to enable subjecting it to subsequent catalytic processes.

There are several known methods to remove or decrease the amount of harmful materials, and varying purification or pre-treatment methods are commonly applied. Exemplary pre-treatment methods suitable for the present disclosure comprise treating with mineral acids, degumming, treating with hydrogen, heat treating, deodorizing, washing with water, treating with base, demetallation, distillation, removal of solids, bleaching, and any combinations thereof.

Contaminating metals may be removed from the feedstock e.g., by treatment with mineral acids. Phosphorus which mostly occurs in the form of phosphates may be removed by degumming. Triglycerides can also be pre-hydrogenated (pre-treated with hydrogen). Besides reducing the amount of oxygen containing compounds (HDO), unsaturation, sulphur, and nitrogen content (HDS, HDN) are reduced. Solid feedstocks such as fats, in turn should be liquified e.g., by heating prior to subjecting to hydrodeoxygenation. Pre-treatment of solid feedstocks may further include one or more of: grinding, agitating, filtering, and sonicating. The feedstock may further be bleached and/or deodorized.

The pre-treatment can be selected from heat treatment optionally followed by evaporation of volatiles; heat treatment with adsorbent (HTA), optionally followed by flash evaporation; degumming; bleaching. According to one embodiment the pre-treatment includes any one of, any combination of, or all of a degumming step, a chemical treating step, a water-wash step, a demetallation step, a bleaching step, a full (or partial) hydrogenation step, an acid gas removal step, and/or a water removal step. The pre-treatment also typically comprises a step of removing impurities from the feedstock, including any suitable removal of solids from a liquid, including filtration, centrifugation, and sedimentation; and removing volatiles from liquid, e.g., by evaporation. In the pre-treatment the feedstock comprising organic material of biological origin, as previously defined, is purified and a purified feedstock is obtained.

In one embodiment the pre-treatment is selected from heat treatment optionally followed by evaporation of volatiles, whereby the feedstock is heated at a temperature of from 80° C. to 325° C., preferably 180° C. to 300° C., more preferably 200° C. to 280° C., in a residence time from 1 to 300 min. The heat treatment can be followed by an evaporation step, where especially silicon and phosphorous containing compounds are removed. An example of heat treatment of a feedstock comprising organic material can be found in WO 2020/016405. Heat treatment can also be followed by filtration as an addition or an alternative to evaporation. When the feedstock comprises brown grease or acidulated soap stock the pre-treatment comprises typically heat treatment with or without a filter-aid (adsorbent) followed by filtration and possible bleaching.

In one embodiment the pre-treatment is selected from heat treatment with adsorbent (HTA) optionally followed by flash evaporation. HTA as pre-treatment is especially suitable when the feedstock comprises CTO and/or TOP, but HTA is also suitable for other feedstocks. Heat treatment with adsorbent (HTA) can be performed in a temperature from 180° C. to 325° C., preferably from 200° C. to 300° C., more preferably from 240° C. to 280° C., optionally in the presence of an acid. The adsorbent can be selected from alumina silicate, silica gel and mixtures thereof and is typically added in an amount of 0.1 wt-% to 10 wt-%, such as 0.5 wt-%. An example of HTA can be found in WO 2020/016410.

In one embodiment the pre-treatment is selected from bleaching. Bleaching can be conducted by acid addition in an amount of from 500 to 5000 ppm based on feed. The bleaching treatment can be performed in a temperature from 60° C. to 90° C. and including a drying step in 110° C. to 130° C. The bleaching is finished by a filtration step to remove formed solids and possible filter aids. In one example bleaching includes the following sequence
(1) acid addition 1000-4000 ppm citric acid (50 wt-% water) 85° C., 10 min;
(2) adsorbent/filter aid addition 0.1-1 wt-%, 85° C., 800 mbar, 20 min;
(3) drying 120° C., 80 mbar, 25 min
(4) filtering 120° C., 2.5 bar.

Both heat treatment (HT) and heat treatment with adsorbent (HTA) can be performed under pressure, the pressure can be from 500 to 5000 kPa. Also, water can be added before or during HT and HTA to a level of up to 5 wt-%, such as 1 wt-%-3 wt-%. The evaporation e.g., flashing can be performed after HT or HTA or any other pre-treatment stage and can be performed at about 160° C., such as from 150° C. to 225° C., in a pressure of 10 to 100 mbar.

In one embodiment the pre-treatment comprises heat treatment (HT) and bleaching.

In one embodiment the pre-treatment comprises heat treatment (HT) with alkali addition and bleaching.

In one embodiment the pre-treatment comprises heat treatment with adsorption (HTA) followed by flash (removal of light components comprising Si components etc. by evaporation) and bleaching.

In addition, the pre-treatment may or may not include additional steps such as removal of solids (using technologies such as centrifugation or filtration) before and/or after HT or HTA, water washing, degumming, hydrolysis, distillation, strong acid treatment, 2nd bleaching or any combination of the mentioned methods.

Feedstock suitably purified by pre-treatment prolongs the catalyst life cycle in hydrodeoxygenation and subsequent reactions like isomerization or cracking.

### Hydrodeoxygenation

As defined herein deoxygenation is a method for the removal of covalently bound oxygen from organic molecules. Hydrodeoxygenation refers herein to removal of oxygen as H₂O, CO₂ and/or CO from the oxygen containing hydrocarbons by hydrodeoxygenation, decarboxylation and/or decarbonylation. Whereas during catalytic cracking, there will be acid catalyzed breaking down of C—C bonds of hydrocarbons or breaking down long chained hydrocarbons to form shorter hydrocarbon chains or branching or cyclisation without the need for presence of molecular hydrogen, merely under the influence of a suitable catalyst.

As defined herein hydrogenation is a method for saturation of carbon-carbon double bonds by means of molecular hydrogen under the influence of a catalyst.

The hydrotreatment comprising deoxygenation and catalytic cracking may be conducted in separate reactors, or at least in multiple catalyst bed systems in separate catalyst beds due to different requirements for reaction conditions. Preferably, the deoxygenation and catalytic cracking are conducted in separate deoxygenation and catalytic cracking steps in subsequent catalyst beds in separate reactors. This will provide flexibility to optimize process conditions separately to favor each type of process. Moreover, this further enables removal of unwanted components in between the processes, enhancing the selectivity and yield of the latter process.

According to the present method the pre-treated feedstock is subjected to hydrodeoxygenation. The hydrodeoxygenation of renewable oxygen containing hydrocarbons is performed at reaction conditions comprising one or more of
a. a temperature in the range from 250° C. to 400° C., preferably from 260° C. to 380° C., more preferably from 280° C. to 360° C., such as from 300° C. to 330° C.,
b. a pressure in the range from 10 bar to 200 bar, preferably from 20 bar to 100 bar, more preferably from 20 bar to 80 bar,
c. a weight hourly space velocity (WHSV) in the range from 0.25 h⁻¹ to 3.0 h⁻¹, preferably from 0.5 h⁻¹ to 3.0 h⁻¹, more preferably from 0.7 h⁻¹ to 2.5 h⁻¹, most preferably from 1.0 h⁻¹ to 2.0 h⁻¹, depending on the hydrogen consumption,
d. a H₂ flow in the range from 350 to 1500 N-L H₂/L feed, more preferably from 350 to 1100 N-L H₂/L feed, most preferably from 350 to 1000 N-L H₂/L feed, wherein N-L H₂/L means normal liters of hydrogen per liter of the feed into the HDO reactor, and
e. a hydrodeoxygenation catalyst selected from Pd, Pt, Ni, Co, Mo, Ru, Rh, W, or any combination of these on a support, preferably Ni, Co, Mo, and W, or any combination thereof on a support.

According to one embodiment the hydrodeoxygenation catalyst is selected from a group consisting of CoMo, NiMo, NiW, and CoNiMo on a support, wherein the support is preferably alumina and/or silica.

According to a particular embodiment the hydrodeoxygenation reaction conditions comprise temperature in the range from 250° C. to 400° C., pressure in the range from 20 bar to 80 bar, a WHSV in the range from 0.5 h⁻¹ to 3 h⁻¹, and H₂ flow of 350-1500 N-L H₂/L feed, and a hydrodeoxygenation catalyst.

In one embodiment, the hydrodeoxygenation of renewable oxygen containing hydrocarbons is most preferably carried out in the presence of sulphided NiMo or sulphided CoMo catalysts on a support in the presence of hydrogen gas. Using a sulphided catalyst, the sulphided state of the catalyst may be maintained during the HDO step by an addition of sulphur in the gas phase or by using a feedstock having sulphur containing mineral oil blended with the renewable oxygen containing hydrocarbons. Sulphur may be deliberately added to the feedstock being subjected to hydrodeoxygenation, for example, within a range from 50 w-ppm (ppm by weight) to 20 000 w-ppm, preferably within a range from 100 w-ppm to 1000 w-ppm, when using hydrodeoxygenation catalysts requiring a sulphided form for operation.

Effective conditions for hydrodeoxygenation may reduce the oxygen content of the renewable oxygen containing hydrocarbons, such as fatty acids or fatty acid derivatives, to less than 1 wt-%, such as less than 0.5 wt-% or less than 0.2 wt-%.

### Purification of the Hydrodeoxygenated Stream

The effluent of the hydrodeoxygenation step, i.e., the hydrodeoxygenated stream, may be purified before subjecting it to the catalytic cracking. Typically, the purification includes subjecting the effluent to a gas-liquid separation i.e., removing gases, such as carbon monoxide, carbon dioxide, water, possible hydrogen sulphide and ammonia, and low boiling hydrocarbons, such as C1-C4 which may be recycled back to the processing or recovered and combines later into corresponding product fractions, from the liquid hydrocarbon stream. In the gas-liquid separation the hydrodeoxygenated effluent is separated into a gaseous stream and into a hydrodeoxygenated liquid stream, which separation may be a stripping step or be followed by a stripping step, where the hydrotreated liquid stream may be stripped with a stripping gas, such as hydrogen. This may occur in a high temperature and/or high-pressure separation step, for example, at a temperature between 300° C. and 330° C. and pressure between 40 bar and 50 bar.

In one embodiment the obtained purified liquid hydrocarbon stream may be separated into suitable carbon number ranges for further processing e.g. by distillation.

The hydrodeoxygenated liquid stream used for catalytic cracking comprises preferably at least 92 wt-%, more preferably at least 95 wt-%, most preferably at least 99 wt-% paraffins of the total weight of the hydrocarbons. Typically, the reminder comprises some oxygen reminder. The effluent stream is still mainly in liquid form.

For most of the feeds the amount of n-paraffins obtainable by the HDO effluent is high, preferably more than 85 wt-%, more preferably more than 90 wt-%, e.g., such as 95 wt-% when using NiMo/Al₂O₃ as the hydrodeoxygenation catalyst.

HDO effluent may optionally be subjected to at least a partial isomerization at isomerization conditions to obtain at least partially isomerized hydrocarbon stream, provided that gasses formed during HDO are first separated from the HDO effluent before entering it into isomerization. The isomerization conditions comprise an isomerization catalyst, temperature, and pressures suitable thereto. Isomerization may be performed in the presence of one or more catalyst(s) comprising a Group VIII metal and/or a molecular sieve, on a support. The metal is preferably Pt, Pd, or Ni. The molecular sieve may be selected from SAPO-11, SAPO-41, ZSM-22, ZSM-23 and fernerite. The support is selected from silica, alumina, clays, titanium oxide, boron oxide or zirconia, which can be used alone or as a mixture. The hydroisomerization may be performed at a temperature of 300-500° C., such as 300-370° C., and at a pressure of 10-150 bar, such 20-50 bar, in the presence of hydrogen. The optional isomerization may be performed in the same reactor with HDO or in a separate reactor.

Effective conditions for hydrodeoxygenation may reduce the oxygen content of HDO effluent, to less than 1 wt-%, such as less than 0.5 wt-% or less than 0.2 wt-%.

It is generally known that alkane and paraffin are synonyms and can be used interchangeably. Isoparaffins (i-paraffins) are branched, open chain paraffins, and normal paraffins (n-paraffins) are unbranched linear paraffins. In the context of this disclosure, the term “paraffin” refers to n-paraffins and/or isoparaffins. Similarly, the term “paraffinic” refers herein to compositions comprising n-paraffins and/or isoparaffins.

### Hydrocracking

The hydrodeoxygenated liquid stream is subjected to hydrocracking reaction comprising a temperature in the range from 250° C. to 420° C., preferably from 250° C. to 400° C., more preferably from 250° C. to 370° C., even more preferably from 250° C. to 350° C., most preferably from 250° C. to 340° C., in the presence of hydrogen flow, and a hydrocracking catalyst. The hydrocracking catalyst comprises
i. a hydrogenation metal,
ii. a mesoporous molecular sieve embedded with zeolite, wherein the zeolite is selected from ZSM-23 and Beta zeolite, and
iii. a carrier.

The hydrogenation metal may be selected from metals of Group VIIIb of the Periodic table of Elements (IUPAC). Preferably, it is selected from platinum, palladium, nickel, cobalt, and iridium. More preferably it is platinum, palladium, or nickel, most preferably platinum. The mesoporous molecular sieve embedded with ZSM-23 or Beta zeolite is impregnated with the hydrogenation metal. Accordingly, the hydrogenation metal is dispersed in the mesoporous molecular sieve and in the zeolite.

In the method of the present disclosure, a catalyst comprising a molecular sieve embedded with a zeolite is impregnated with the hydrogenation metal and comprises further a carrier. The molecular sieve embedded with a zeolite is a solid acid material having mesoporous surface area. It is crystalline (not amorphous) and it contains crystalline zeolite phases. The molecular sieve embedded with a zeolite contains only silicon, aluminum, and oxygen. Catalysts based on a molecular sieve embedded with a zeolite have not only zeolite type active sites but also high accessibility of the active sites for reactants and a short diffusion path length of reactants. These catalysts are mechanically, thermally, and hydrothermally stable to allow and favor their use in the conditions of the presently disclosed method.

Mesoporous alumino-silicates known as the MCM-41 group discussed herein as MCM-41 mesoporous molecular sieve provided an attractive starting point for an embedded catalyst due to its pore structure and one-dimensionality. The pore walls of the mesoporous MCM-41 material are amorphous, but with the introduction of a zeolite, they exhibit increased crystallinity. The zeolite unit cell in a mesoporous molecular sieve embedded with a zeolite is different from the one in a mechanical mixture of a zeolite and a mesoporous molecular sieve, and the mesoporous molecular sieve unit cell is larger than the unit cell in a mechanical mixture.

The properties of ZSM-23 and Beta zeolites render them interesting in converting straight chained hydrocarbons into branched hydrocarbons. By suitable modifications to their properties even better results were anticipated to be gained compared to the pure zeolites. The use of these zeolites in structures like the mesoporous molecular sieves embedded with such a zeolite was found to provide surprisingly high selectivities to formation of light hydrocarbons, such as useful gases and naphtha range hydrocarbons, namely C3-C8 hydrocarbons. Moreover, the anticipated extremely high activity was found to be conveniently suppressed. The acidity of the catalytic material may be tailored by the amount of Al introduced into the structure by modifying the aluminum (Al) content in MCM-41 and zeolite phases.

The zeolite in the present disclosure is selected from ZSM-23 and Beta zeolite.

The mesoporous molecular sieve, such as MCM-41, embedded with ZSM-23 zeolite of the present disclosure may have one or more of the following features:
The amount of Si may be from 42 wt-% to 45 wt-%, such as about 42 wt-%, and the amount of Al may be from 0.3 wt-% to 3.3 wt-%, such as from 0.8 wt-% to 2.6 wt-%. These will provide the MCM-41 embedded with ZSM-23 a Si to Al molar ratio from 12 to 140, preferably from 15 to 50, more preferably from 32 to 40.
The BET (Brunauer-Emmett-Teller) surface area may be from 675 m²/g to 810 m²/g, such as from 740 m²/g to 780 m²/g, determined by nitrogen physisorption.
The BJH (Barrett-Joyner-Halenda) pore area may be from 600 m²/g to 800 m²/g, such as from 680 m²/g to 740 m²/g, determined by nitrogen physisorption.
The mesoporous molecular sieve embedded with ZSM-23 may have an acidity from 70 μmol/g to 250 μmol/g, such as from 95 μmol/g to 200 μmol/g, measured with NH₃-TPD method, which particular method is described and discussed in detail in the applicant's former patent application WO2006070073A1, p. 10.
The total pore volume of the mesoporous molecular sieve embedded with ZSM-23 may be from 0.65 cm³/g to 0.81 cm³/g, such as from 0.75 cm³/g to 0.85 cm³/g, such as about 0.8 cm³/g. The volume of the mesopores may be from 0.56 cm³/g to 0.75 cm³/g, such as from 0.65 cm³/g to 0.75 cm³/g, such as about 0.70 cm³/g, as determined by the nitrogen physisorption.
The crystallinity of the mesoporous molecular sieve embedded with ZSM-23 is quite low, it may be less than 35%, such as from 25 to 35%, such as about 30% measure by X-ray diffraction (XRD) according to ASTM D5758-01 (2021).
The maximum diameter of the sphere is about 0.62 nm.

The mesoporous molecular sieve embedded with Beta zeolite of the present disclosure may have one or more of the following features:
The amount of Si may be from 40 wt-% to 44 wt-%, and the amount of Al may be from 1.0 wt-% to 6.0 wt-%, such as from 1.5 wt-% to 2.4 wt-%. These will provide the mesoporous molecular sieve embedded with Beta zeolite a Si to Al molar ratio from 6 to 40, preferably from 19 to 21.
The BET (Brunauer-Emmett-Teller) surface area may be from 620 m²/g to 880 m²/g, such as from 740 m²/g to 780 m²/g.
The BJH (Barrett-Joyner-Halenda) pore area may be from 565 m²/g to 900 m²/g, such as from 650 m²/g to 700 m²/g.
The mesoporous molecular sieve embedded with Beta zeolite may have an acidity from 110 μmol/g to 430 μmol/g, such as from 175 μmol/g to 185 μmol/g, measured with NH₃-TPD method, which particular method is described and discussed in detail in the applicant's former patent application WO2006070073A1, p. 10.
The total pore volume of the mesoporous molecular sieve embedded with Beta zeolite may be from 0.50 cm³/g to 0.94 cm³/g, such as from 0.58 cm³/g to 0.70 cm³/g, such as about 0.63 cm³/g. The volume of the mesopores may be from 0.41 cm³/g to 0.74 cm³/g, such as from 0.49 cm³/g to 0.65 cm³/g, such as about 0.58 cm³/g.
The crystallinity of the mesoporous molecular sieve embedded with Beta zeolite is quite low, it may be less than 35%, such as from 25 to 35%, such as about 30%.

In comparison to the mesoporous molecular sieve, in particular MCM-41, embedded with ZSM-23 of the present disclosure, the pure ZSM-23 used as reference material in comparison with e.g. the MCM-41 embedded with ZSM-23 has a Si/Al ratio is from 36 to 38, such as about 38; a crystallinity from 40 to 50%, such as about 43%; a BET surface area from 250 to 260 m²/g, such as about 257 m²/g, determined by N₂ physisorption; and the acidity is from 380 to 390 μmol/g, such as about 386 μmol/g.

Similarly, in comparison to the mesoporous molecular sieve, in particular MCM-41, embedded with Beta zeolite of the present disclosure, pure Beta zeolite used as reference material in comparison with the e.g., MCM-41 embedded with Beta has pore volume 0.32 cm³/g, average pore size 2.35 nm, BET surface area of about 534 m²/g determined by N₂ physisorption, a crystallinity of more than 52%, determined by XRD according to ASTM D5758-01 (2021), and a Si/Al ratio of about 129.

As disclosed above, the mesoporous molecular sieve is preferably MCM-41. The most preferred MCM-41 is mesoporous, hexagonal and has regular one-dimensional pore structure although the walls are amorphous. According to high resolution transmission electron microscopic (HR-TEM) analysis, the pore size of the MCM-41 may be around 2.4-2.6 nm.

The carrier may be selected from clay, alumina, silica, and zirconia. Preferably, it comprises alumina.

In one embodiment, the catalyst of the present disclosure is a platinum impregnated mesoporous molecular sieve, in particular MCM-41, embedded with ZSM-23 zeolite on an alumina carrier. The catalyst has most preferably a Si to Al molar ratio from 15 to 50; a BET surface area from 740 m²/g to 780 m²/g; an acidity from 95 μmol/g to 200 μmol/g; a total pore volume about 0.8 cm³/g; a volume of the mesopores about 0.70 cm³/g; and a crystallinity of about 30%. The values are determined as explained above.

In one embodiment, the catalyst of the present disclosure is a platinum impregnated mesoporous MCM-41 embedded with Beta zeolite on an alumina carrier. The catalyst has most preferably a Si to Al molar ratio from 19 to 21; a BET from 740 m²/g to 780 m²/g; an acidity from 175 μmol/g to 185 μmol/g; a total pore volume from 0.58 cm³/g to 0.70 cm³/g, such as about 0.63 cm³/g; a volume of the mesopores from 0.49 cm³/g to 0.65 cm³/g, such as about 0.58 cm³/g; and a crystallinity from 25 to 35%, such as about 30%. The values are determined as explained above.

The mesoporous molecular sieve, such as MCM-41, embedded with a zeolite, such as ZSM-23 or Beta, may be synthesized as disclosed in EP1830956 by the following steps A-I.
A. Preparing a zeolite nuclei from a silicon source, an aluminum source and a structure directing agent and optionally removing the structure directing agent with a step calcination procedure.
B. Preparing a mesoporous molecular sieve gel mixture from a silicon source, an optional aluminum source, and surfactant.
C. Introducing the zeolite nuclei prepared in the step A to the mesoporous molecular sieve gel mixture obtained in the step B and homogenizing and dispersing in the molecular sieve gel the zeolite nuclei and introducing an additional aluminum source to the obtained mixture.
D. Performing gel ripening of the mixture of step C under stirring.
E. Carrying out hydrothermal synthesis of the mixture of the step D by maintaining the mixture under sufficient conditions including a temperature of from about 100° C. to about 200° C. under static or dynamic mode of stirring until crystals are formed.
F. Recovering the crystals.
G. Washing off the solid products.
H. Drying the solid products, and
I. Removing the surfactant partly or totally with a step calcination procedure and optionally the structure directing agent if it was not removed in step A, whereby a mesoporous molecular sieve embedded with a zeolite catalyst is obtained.

The embedded catalyst may be impregnated with a hydrogenation metal i.e., a metal active to catalyze hydrogenation reactions is selected from platinum, palladium, nickel, cobalt, and iridium and any combinations thereof, such as Pd, Pt, Pd—Pt and Pt—Ir, preferably platinum. The impregnation may be achieved by known dry or wet methods. According to an exemplary embodiment Pt is impregnated using an aqueous Pt(NH₃)₄Cl₂ or Pt(NH₃)₄(NO₃)₂ solution. The metal, in particular platinum, may be added to the catalyst material alone or including a carrier such as alumina or silica.

The metal, such as Pt, content may be from 0.3 wt-% to 1.0 wt-%, preferably from 0.4 wt-% to 0.6 wt-%, such as about 0.5 wt-%. The metal loading and dispersion are important factors in order to have a proper balance between the metal and the acid functions in the catalyst. A loading around 0.5-1.0 wt-% creates a good balance between metallic and acid sites. The attentional amount of metal neither affects the surface area nor acidity (NH₃-TPD) of the final catalyst.

In one embodiment, the platinum is added by incipient wetness impregnation as follows: Pt(NH₃)₄(NO₃)₂ is used as the Pt source chemical. The pore volume of the catalyst is measured by water titration. The platinum source is dissolved into the water content measured. The amount of catalyst material and the amount of Pt(NH₃)₄(NO₃)₂ is selected suitably. The catalyst is impregnated, dried at 115° C. overnight, and calcined at 350° C. in air for two hours.

Prior to the hydrocracking reaction, the catalyst is typically subjected to pre-treatment including drying, reduction, wetting and stabilization. Exemplary pre-treatment process parameters are summarized below:
Drying: 125° C., 8 h, N₂ flow
Reduction: 350° C., 2 h, 40 bar, H₂ flow
Wetting: 200° C., 2 h, 40 bar, H₂ flow
Stabilization: 200° C., 2 h, 40 bar, H₂ flow

The hydrocracking reaction is typically performed at H₂ pressure of 1-50 bar. Exemplary hydrocracking reaction conditions comprise temperature 280-340° C., pressure 1-50 bar, WHSV 1.3 h⁻¹, and H₂/feed ratio 300 N-L/L. The processing temperature refers to the temperature at the process inlet.

The catalyst may occasionally be regenerated. The regeneration is conveniently carried out in facilities for catalyst regeneration, which complement the reactor zone used in the method. If desired, the operation may be interrupted for catalyst regeneration, however, in continuous industrial operation it is preferred to include several reactors in the system and carry out regeneration in one reactor at a time while allowing production in other reactors. As an example of such arrangement, there may be two or more fixed bed reactors connected in such a manner that each of them can be separated from the process for changing or regeneration of the catalyst. Alternatively, a reactor from which the catalyst can be extracted continuously for regeneration may be used. For this purpose, a fluidized bed reactor or a spouted bed reactor is suitably used, from which the catalyst can be extracted continuously and recycled through a regeneration facility.

### Separation

The hydrocracked stream is subjected to a separation step to give rise to at least a fraction comprising C3-C8 hydrocarbons.

The separating may comprise one or more of distilling, fractionating, evaporating, flash-separating, membrane separating, extracting, using extractive-distillation, using chromatography, using molecular sieve adsorbents, using thermal diffusion, complex forming, preferably at least fractionating, distilling, extracting, using extractive-distillation.

A fraction comprising C3-C8 hydrocarbons, i.e., a fraction rich in C3-C8 hydrocarbons, means in the context of the present disclosure that the wt-% amount of the C3-C8 hydrocarbons in the fraction, based on the total weight of the fraction, is higher than the wt-% amount of the C3-C8 hydrocarbons in the hydrocracked stream based on the total weight of the hydrocracked stream.

The fraction rich in C3-C8 hydrocarbons can be fractionated further. The fractionation may be conducted in several steps. For example, a first separating step from the hydrocracked stream, may produce a first C3-C8 hydrocarbon composition. Thereafter, a second separating step from the first C3-C8 hydrocarbon composition may produce a second further enriched C3-C8 hydrocarbon composition, as well as a fraction enriched in C3 hydrocarbons, a fraction enriched in C4 hydrocarbons, and a fraction enriched in C5-C8 hydrocarbons.

This kind of staged separation of some of the desired fractions may be beneficial, e.g., when also other, close fractions are to be recovered as their own fractions.

Any of the separated fractions may be subjected to one or more further purification and/or fractionation steps. The optional purification and/or fractionation steps or treatments may be selected depending on the intended end use and/or desired degree of purity of the C3-C8 hydrocarbons.

According to one embodiment, the method comprises separating the fraction rich in C3-C8 hydrocarbons at least to
i) a fraction rich in C5-C8 hydrocarbons, and optionally also
ii) a fraction rich in C4 hydrocarbons, and
iii) a fraction rich in C3 hydrocarbons.

In certain embodiments the process further comprises purifying the fraction rich in C3 hydrocarbons, the fraction rich in C4 hydrocarbons, and/or the fraction rich in C5-C8 hydrocarbons until the total content of the C3 hydrocarbons, C4 hydrocarbons and/or the C5-C8 hydrocarbons reaches at least 85 wt-%, preferably at least 90 wt-%, more preferably at least 95 wt-%, even more preferably at least 99 wt-% or at least 99.5 wt-%, based on the total weight of the fractions.

The possible remainder of hydrocarbons higher than C9 may be recovered and used for e.g., diesel fuel production

According to one embodiment, the C3 hydrocarbons are subjected to dehydrogenation to produce propene.

According to one embodiment, the C4 hydrocarbons are subjected to dehydrogenation to produce butene.

According to another embodiment, the C5-C8 hydrocarbons are fed to a steam cracking unit to give rise to ethene, propene and other low hydrocarbons.

A preferred fraction for liquid crackers is light naphtha, such as C5-C7 hydrocarbons, but may also include hydrocarbons up to C10 or even higher, such as at least C16. Moreover, some furnaces are designed for hydrocarbons in e.g., the LPG (liquefied petroleum gas) range.

According to a further embodiment, a stream comprising the C3-C4 hydrocarbons obtained by method of the present disclosure may be subjected to steam cracking.

According to a yet further embodiment, a stream comprising the C9-C16 hydrocarbons obtained by method of the present disclosure may be subjected to steam cracking.

The possible remainder of hydrocarbons higher than C8 may be recovered and used for fuel production e.g., diesel fuel production.

The present invention also concerns use of a catalyst comprising a hydrogenation metal, a mesoporous molecular sieve embedded with ZSM-23 zeolite or Beta zeolite, and a carrier for producing renewable C3-C8 hydrocarbons from a renewable paraffinic feed by hydrocracking at a temperature from 250 to 420° C., preferably 250-400° C., more preferably 250-370° C., even more preferably 250-350° C., most preferably 250-340° C. in the presence of a hydrogen flow. The mesoporous molecular sieve is preferably MCM-41. The hydrogenation metal is preferably selected from platinum, palladium, nickel, cobalt, and iridium and any combinations thereof, preferably platinum from platinum, palladium, nickel, cobalt, and iridium, preferably platinum. An exemplary catalyst is platinum impregnated MCM-41 embedded with ZSM-23. Another exemplary catalyst is platinum impregnated MCM-41 embedded with Beta zeolite. The use of the catalyst embedded with ZSM-23 is beneficial when the production of n-C5-C8 hydrocarbons is desired, for e.g., the feed of steam cracking. The use of the catalyst embedded with Beta zeolite is beneficial when the production of i-C5-C8 hydrocarbons is desired.

### EXPERIMENTAL

The hydrocracking catalysts tested were the mesoporous molecular sieve MCM-41 embedded with ZSM-23 zeolite and impregnated with 0.5 wt-% platinum (Pt/MCM-41 embedded with ZSM-23) and the mesoporous molecular sieve MCM-41 embedded with Beta zeolite and impregnated with 0.5 wt-% platinum (Pt/MCM-41 embedded with Beta). They were synthesized using the method disclosed in WO2006070073A1 and have the features as those described in the most preferred embodiments of the description above.

Acidity of the catalyst used in the present disclosure was measured by using the NH₃-TPD method as disclosed and described in WO2006070073A1 p. 10 lines 7-20. Accordingly, total acidity of catalytic materials was measured by temperature-programmed desorption of ammonia (NH₃-TPD) using Altamira AMI-100 instrument. Sample size was 40 mg. The total acidity was measured by desorption of NH₃ as a function of temperature. The acidity of the samples was calculated from the amount of NH₃ adsorbed at 200° C. and desorbed between 100° C. and 500° C. The NH₃-TPD instrument was equipped with a thermal conductivity detector (TCD) manufactured by company Gow Mac. A ramp rate of 20° C./min was applied and the temperature was linearly raised to 500° C. where it was held for 30 min. The quantification was made using pulses of known volume of 10% NH₃ in He.

In the following, the above-mentioned catalysts are compared to the performance of reference catalysts, Pt/ZSM-23 and Pt/Beta, both impregnated with 0.5 wt-% of platinum.

The fresh catalysts were tested without passivation. Passivation is anticipated to enhance the performance of catalysts, e.g., in terms of selectivity, but it was not considered to essentially affect the comparative results. The equipment used consisted of 16 individual stainless steel fixed-bed reactors, which could be run in parallel. After drying the catalyst were reduced but not passivated. The conversion of n-hexadecane (C16), which was used to mimic the HDO effluent feed, was investigated at three different temperatures (280° C., 295° C. and 310° C.). In the present type of tests, a carrier or a support was not necessary, the results will remain the same without having a support neither for the catalysts according to the invention nor for the reference catalysts. However, when operating an industrial scale reactor, support will be required, specifically for mechanical reasons.

The analysis of the gaseous products was made with an online GC (Agilent 7890) The analysis of the liquid products was made with an offline GC (QP2010 Ultra El, Shimadzu) having an FID and mass spectrometer.

The process parameters used in the different steps of the experiment are summarized below:
Drying: 125° C., 8 h, N₂ flow
Reduction: 350° C., 2 h, 40 bar, H₂ flow
Wetting: 200° C., 2 h, 40 bar, H₂ flow
Stabilization: 200° C., 2 h, 40 bar, H₂ flow
Reaction: 280-340° C., 40 bar, WHSV 1.3 h⁻¹, H₂/oil ratio 300 N-L/L feed, 40 mg catalyst (50-100 μm).

The conversion (wt-%) of the feed for all the tested catalysts at different temperatures is shown in Table 1.

TABLE 1

| Conversion | 280° C. | 295° C. | 310° C. |
|---|---|---|---|
| Pt/ZSM-23 (ref.) | 98 | 99 | 100 |
| Pt/Beta (ref.) | 71 | 99 | 100 |
| Pt/MCM-41 embedded with ZSM-23 | 91 | 100 | 100 |
| Pt/MCM-41 embedded with Beta | 100 | 100 | 100 |

One of the surprising findings in screening the catalysts was that the embedded materials have a much higher tendency towards cracking to the lighter hydrocarbons than their ZSM-23 and Beta counterparts.

The high hydrocracking activity of the embedded materials is reflected in a high yield of products ranging from C3 to C8. Of the embedded materials, MCM-41 embedded with Beta, provided a yield above 90 wt-% for C3-C8 hydrocarbons at the tested temperatures, and full conversion to C3-C8 was reached at 310° C. (Table 2). It should be noted that methane was not detected at all, and ethane was only detected in very small amounts.

The highest yield to C3 and naphtha range hydrocarbons was obtained by MCM-41 embedded with Beta zeolite. The MCM-41 embedded with ZSM-23 zeolite forms less hydrocarbons ranging from C3-C8 than MCM-41 embedded with Beta zeolite. However, the MCM-41 embedded with zeolites yielded much more C3-C8 hydrocarbons than the reference ZSM-23 catalyst (Table 2). Table 2 depicts the C3-C8 yields (wt-%) obtained from the hydrocracked feed at different temperatures.

TABLE 2

| C3-C8 yield (wt-%) | 280° C. | 295° C. | 310° C. |
|---|---|---|---|
| Pt/ZSM-23 (ref.) | 22 | 50 | 75 |
| Pt/Beta (ref.) | 2 | 13 | 52 |
| Pt/MCM-41 embedded with ZSM-23 | 84 | 94 | 97 |
| Pt/MCM-41 embedded with Beta | 94 | 90 | 100 |

Table 3 shows the C3 yields (wt-%) from conversion of the hydrocracked feed at the tested temperatures. Despite not having the highest selectivity for C3-C8 hydrocarbons, MCM-41 embedded with ZSM-23 has the advantage of forming the highest fraction of C3s compared to all catalysts tested in this study.

TABLE 3

| C3 yield (wt-%) | 280° C. | 295° C. | 310° C. |
|---|---|---|---|
| Pt/ZSM-23 (ref.) | 1.3 | 3.1 | 4.9 |
| Pt/Beta (ref.) | 0 | 0.4 | 1.1 |
| Pt/MCM-41 embedded with ZSM-23 | 8.5 | 7.7 | 6.1 |
| Pt/MCM-41 embedded with Beta | 2.9 | 3.8 | 5.5 |

Table 4 shows the C4 yields (wt %) from conversion of the hydrocracked feed at the tested temperatures. The C4 yield (includes n- and iso-butane), however, increased generally with temperature (Table 4). The amount of olefins in the light hydrocarbons is low due to the high H₂ pressure applied in the experiments.

TABLE 4

| C4 yield (wt-%) | 280° C. | 295° C. | 310° C. |
|---|---|---|---|
| Pt/ZSM-23 (ref.) | 3.7 | 9.1 | 15.6 |
| Pt/Beta (ref) | 0.2 | 1.7 | 7.4 |
| Pt/MCM-41 embedded with ZSM-23 | 17.9 | 21.4 | 26.2 |
| Pt/MCM-41 embedded with Beta | 20.0 | 22.8 | 29.0 |

Table 5 shows the C5-C8 yields (wt-%) from conversion of the hydrocracked feed at the tested temperatures. The highest yield of the naphtha fraction (C5-C8) was obtained at 280° C. for the MCM-41 embedded with Beta catalyst of about 70 wt-% (Table 5). At higher temperatures (295° C. and 310° C.), the naphtha yield decreased slightly by around 5 wt-%, which is still superior compared to the naphtha yields achieved on the other catalysts. A comparison of the embedded materials with ZSM-23 and Beta catalysts reveals that the embedded catalysts have a much higher tendency for producing naphtha which is most pronounced at the lowest temperature tested (280° C.).

TABLE 5

| C5-C8 yield (wt-%) | 280° C. | 295° C. | 310° C. |
|---|---|---|---|
| Pt/ZSM-23 (ref.) | 16.6 | 37.1 | 52.9 |
| Pt/Beta (ref) | 2.1 | 11.8 | 43.3 |
| Pt/MCM-41 embedded with ZSM-23 | 48.3 | 56.1 | 59.4 |
| Pt/MCM-41 embedded with Beta | 69.7 | 63.3 | 63.3 |

Studying the naphtha fraction produced by the different catalysts shows that the MCM-41 embedded with ZSM-23 catalyst tends to form n-paraffins independent of the temperature. This feature might come from the ZSM-23 phase as also the reference ZSM-23 catalyst partly shows a similar tendency (Tables 6-8). In all the other products the amount of iso-paraffins was higher compared to the amount of n-paraffins. Table 6 shows the sum of i- and n-paraffins of the C5-C8 fractions from conversion of the feed used at 280 00 whereas Table 7 shows the situation at 295 00, and table 8 at 31000.

TABLE 6

| Catalyst T = 280° C. | i-C5-C8 | n-C5-C8 |
|---|---|---|
| Pt/ZSM-23 (ref.) | 5.1 | 11.5 |
| Pt/Beta (ref) | 1.1 | 1.0 |
| Pt/MCM-41 embedded with ZSM-23 | 11.3 | 37.0 |
| Pt/MCM-41 embedded with Beta | 56.1 | 13.6 |

TABLE 7

| Catalyst T = 295° C. | i-C5-C8 | n-C5-C8 |
|---|---|---|
| Pt/ZSM-23 (ref.) | 14.4 | 22.7 |
| Pt/Beta (ref) | 8.0 | 3.8 |
| Pt/MCM-41 embedded with ZSM-23 | 15.3 | 40.8 |
| Pt/MCM-41 embedded with Beta | 50.6 | 12.7 |

TABLE 8

| Catalyst T = 310° C. | i-C5-C8 | n-C5-C8 |
|---|---|---|
| Pt/ZSM-23 (ref.) | 28.7 | 24.2 |
| Pt/Beta (ref) | 32.5 | 10.8 |
| Pt/MCM-41 embedded with ZSM-23 | 20.7 | 38.7 |
| Pt/MCM-41 embedded with Beta | 48.9 | 14.4 |

Accordingly, embedded zeolites can markedly increase the propane, n- and i-butane yield and the naphtha fraction (C5-C8) compared to standard zeolites used as references in the hydrocracking of long chain paraffins. The selection of the embedded material depends on the application. MCM-41 embedded with Beta could be chosen if a high isomerized C4-C8 yield is targeted but MCM-41 embedded with ZSM-23 could be advantageous if a high propane yield at lower temperature and a high selectivity towards n-paraffins in the naphtha range is targeted.

A paraffinic product may be preferred as it may increase ethylene and total light olefin yields. On the other hand, high degree of branching increases propylene and, in particular, i-C4 olefin yields.

The specific examples provided in the description given above should not be construed as limiting the scope and/or the applicability of the appended claims. Lists and groups of examples provided in the description given above are not exhaustive unless otherwise explicitly stated.

1-24. (canceled)

25. A method for producing renewable C3-C8 hydrocarbons from a renewable feedstock, the method comprising
a) providing the renewable feedstock,
b) pre-treating (10) the renewable feedstock by reducing the amount of impurities therein not to include: more than 10 w-ppm alkali metal and alkaline earth metal impurities, calculated as elemental alkaline and alkaline earth metals; more than 10 w-ppm other metals, calculated as elemental metals; more than 1000 w-ppm nitrogen containing impurities, calculated as elemental nitrogen; more than 30 w-ppm phosphorus containing impurities, calculated as elemental phosphorus; more than 5 w-ppm silicon containing impurities, calculated as elemental silicon; to produce pre-treated feedstock, wherein the pretreating is selected from treating with mineral acids, degumming, treating with hydrogen, heat treating, deodorizing, and bleaching,
c) subjecting the pre-treated feedstock to hydrodeoxygenation reaction (20) to produce a hydrodeoxygenated stream, wherein the hydrodeoxygenation reaction comprises one or more of:
a. a temperature in the range from 250° C. to 400° C.,
b. a pressure in the range from 10 bar to 200 bar,
c. a WHSV in the range from 0.25 to 3 h⁻¹,
d. a H₂ flow of 350 to 1500 n-L H₂/L feed, and
e. a hydrodeoxygenation catalyst selected from Pd, Pt, Ni, Co, Mo, Ru, Rh, and W or any combination thereof, on a support,
d) subjecting the hydrodeoxygenated stream to a gas-liquid separation (30) thereby producing a gaseous stream and a hydrodeoxygenated liquid stream,
e) subjecting the hydrodeoxygenated liquid stream to hydrocracking reaction (40) comprising a temperature in the range from 250° C. to 420° C., hydrogen, and a catalyst comprising
i. a hydrogenation metal,
ii. a mesoporous molecular sieve embedded with zeolite, wherein the zeolite is selected from ZSM-23 zeolite and Beta zeolite, and
iii. a carrier
to yield a hydrocracked stream and
f) separating (50) the renewable C3-C8 hydrocarbons from the hydrocracked stream.

26. The method according to claim 1 wherein the temperature of step e) is 250-400° C., preferably 250-370° C., more preferably 250-350° C., most preferably 250-340° C.

27. The method according to claim 1 wherein in step c) temperature is from 260° C. to 380° C., preferably from 280° C. to 360° C., such as from 300° C. to 330° C., pressure is from 20 bar to 100 bar, preferably from 20 bar to 80 bar, a weight hourly space velocity (WHSV) is in the range from 0.5 h⁻¹ to 3.0 h⁻¹, preferably from 0.7 h⁻¹ to 2.5 h⁻¹, most preferably from 1.0 h⁻¹ to 2.0 h⁻¹ and H₂ flow is in the range from 350 to 1100 N-L H₂/L feed, preferably from 350 to 1000 N-L H₂/L feed.

28. The method according to claim 1 comprising fractionating the renewable C3-C8 hydrocarbons at least to
i. a fraction rich in renewable C5-C8 hydrocarbons, and optionally also
ii. a fraction rich in renewable C3 hydrocarbons, and
iii. a fraction rich in renewable C4 hydrocarbons.

29. The method according to claim 1, wherein the hydrogenation metal is selected from platinum, palladium, nickel, cobalt, and iridium and any combinations thereof, preferably platinum.

30. The method according to claim 1, wherein the mesoporous molecular sieve is MCM-41.

31. The method according to claim 1, wherein the carrier is selected from clay, alumina, silica, and zirconia.

32. The method according to claim 1, wherein the hydrogen of step e) is at pressure of 10-50 bar.

33. The method according to claim 1, wherein the hydrodeoxygenation catalyst is selected from a group consisting of CoMo, NiMo, NiW, and CoNiMo on a support, wherein the support is preferably alumina and/or silica.

34. The method according to claim 1, wherein the hydrodeoxygenation reaction comprise temperature in the range from 250° C. to 400° C., pressure in the range from 20 bar to 80 bar, a WHSV in the range from 0.5 h⁻¹ to 3 h⁻¹, and H₂ flow of 350-1500 N-L H₂/L feed, preferably from 350 to 1100 N-L H₂/L feed, most preferably from 350 to 1000 N-L H₂/L feed, and a hydrodeoxygenation catalyst.

35. The method according to claim 1, wherein the hydrodeoxygenated stream comprises at least 92 wt-%, preferably at least 95 wt-%, more preferably at least 99 wt-% paraffins based on total weight of hydrocarbon products.

36. The method according to claim 1, wherein the feedstock is selected from waste and residues of animal fat or oil, plant fat or oil, and fish fat or oil, and mixtures thereof, preferably the feedstock is selected from palm oil residues and wastes, such as palm effluent sludge, palm oil mill effluent, sludge palm oil, palm oil fatty acid, tall oil material, used cooking oil, acid oils, animal fats, such as brown grease, spent bleaching earth oil, technical corn oil.

37. The method according to claim 1, wherein the feedstock comprises triglycerides and/or fatty acids.

38. The method according to claim 1 wherein the catalyst of step e) is platinum impregnated MCM-41 embedded with ZSM-23, and wherein the catalyst has one of more of the following features
Si to Al molar ratio is from 12 to 140, preferably from 15 to 50, more preferably from 32 to 40,
BET surface area is from 675 m²/g to 810 m²/g determined by nitrogen physisorption,
BJH pore area is from 600 m²/g to 800 m²/g determined by nitrogen physisorption,
acidity is from 70 μmol/g to 250 μmol/g measured with NH₃-TPD method,
total pore volume is from 0.65 cm³/g to 0.81 cm³/g,
volume of the mesopores is from 0.56 cm³/g to 0.75 cm³/g as determined by the nitrogen physisorption, and
crystallinity is 35% or less, such as from 25 to 35% by X-ray diffraction (XRD) according to ASTM D5758-01 (2021).

39. The method according to claim 1, wherein the catalyst of step e) is platinum impregnated MCM14 embedded with Beta zeolite and wherein the catalyst has one of more of the following features
Si to Al molar ratio is from 6 to 40, preferably from 19 to 21,
BET surface area is from 620 m²/g to 880 m²/g, determined by nitrogen physisorption,
BJH pore area is from 565 m²/g to 900 m²/g, determined by nitrogen physisorption,
acidity is from 110 μmol/to 430 μmol/g measured with NH₃-TPD method,
total pore volume is from 0.50 cm³/g to 0.94 cm³/g,
volume of the mesopores is from 0.41 cm³/g to 0.74 cm³/g as determined by the nitrogen physisorption, and
crystallinity is 35% or less, such as from 25 to 35% measured by X-ray diffraction (XRD) according to ASTM D5758-01 (2021).

40. Use of a catalyst comprising a hydrogenation metal, mesoporous molecular sieve embedded with ZSM-23 zeolite or Beta zeolite, and a carrier for producing renewable C3-C8 hydrocarbons from a renewable paraffinic feed by hydrocracking at a temperature from 250° C. to 420° C. in the presence of a hydrogen flow.

41. The use according to claim 16, wherein the mesoporous molecular sieve is MCM-41.

42. The use according to claim 16, wherein the hydrogenation metal is selected from platinum, palladium, nickel, cobalt, and iridium and any combinations thereof, preferably platinum.

43. The use according to any one of claim 16, wherein the catalyst is platinum impregnated MCM-14 embedded with ZSM-23.

44. The use according to any one of claim 16, wherein the catalyst is platinum-impregnated MCM-14 embedded with Beta zeolite.

45. The use according to claim 19, wherein the catalyst has one or more of the following features
Si to Al molar ratio is from 12 to 140, preferably from 15 to 50, more preferably from 32 to 40,
BET surface area is from 675 m²/g to 810 m²/g, determined by nitrogen physisorption,
BJH pore area is from 600 m²/g to 800 m²/g determined by nitrogen physisorption,
acidity is from 70 μmol/to 250 μmol/g measured with NH₃-TPD method,
total pore volume is from 0.65 cm³/g to 0.81 cm³/g,
volume of the mesopores is from 0.56 cm³/g to 0.75 cm³/g as determined by the nitrogen physisorption, and
crystallinity is 35% or less, such as from 25 to 35% measured by X-ray diffraction (XRD) according to ASTM D5758-01 (2021).

46. The use according to claim 20, wherein catalyst has one of more of the following features
Si to Al molar ratio is from 6 to 40, preferably from 19 to 21,
BET surface area is from 620 m²/g to 880 m²/g determined by nitrogen physisorption,
BJH pore area is from 565 m²/g to 900 m²/g, determined by nitrogen physisorption,
acidity is from 110 μmol/to 430 μmol/g measured with NH₃-TPD method,
total pore volume is from 0.50 cm³/g to 0.94 cm³/g,
volume of the mesopores is from 0.41 cm³/g to 0.74 cm³/gas determined by the nitrogen physisorption,
crystallinity 35% or less, such as from 25 to 35% measured by X-ray diffraction (XRD) according to ASTM D5758-01 (2021).

47. The use according to any one of claim 16, wherein the hydrocracking temperature is 250-400° C., preferably 250-370° C., more preferably 250-350° C., most preferably 250-340° C.
